(19) United States
(12) Patent Application Publication
(10) Pub. No.: US 2024/0092062 A1
(43) Pub. Date: Mar. 21, 2024

(54) IMPACT-DAMPENING, UNIDIRECTIONAL MULTI-LAYERED SPALLING-RESISTANT BALLISTIC GLASS

(71) Applicants: Dean Casutt, Lehi, UT (US); Bryant Casutt, Hyrum, UT (US)

(72) Inventors: Dean Casutt, Lehi, UT (US); Bryant Casutt, Hyrum, UT (US)

(21) Appl. No.: 17/949,829

(22) Filed: Sep. 21, 2022

(51) Int. Cl. B32B 17/10; B32B 1/00; B32B 7/12; B32B 37/24; B32B 38/00

(52) U.S. Cl. CPC B32B 17/10; B32B 1/00; B32B 7/12; B32B 37/24; B32B 38/0012; B32B 2250/05; B32B 2255/10; B32B 2255/26; B32B 2264/108; B32B 2307/202; B32B 2307/41; B32B 2307/7265; B32B 2313/04; B32B 2315/08; B32B 2367/00; B32B 2369/00; B32B 2571/02

(57) ABSTRACT

Transparent ballistic glass includes a multilayered glass formed from film, acrylic, glass, polycarbonate and/or a tempered silica able to withstand impact from standardized military rounds most proliferated across the world, such as 5.56×45 mm (0.223), 7.62×39 mm (AK-47), and 7.62×51 mm (0.308). The glass comprises a plurality of layers, including hard layers and soft layers, wherein the hardest layers may position rearwardly in the glass and the softest of the hard layers position foremostly. Various embodiments include recesses spaced between layers to absorb shockwaves, insulate and reduce noise, as well as gridlines and smart glass.

### BACKGROUND OF THE INVENTION

### Field of the Invention

This invention relates to composite armor and ballistic glass. In particular, this invention relates to transparent ballistic glass.

### Description of the Related Art

Vehicles and buildings are often retrofit with armored glass. Often, traditional glass is first stripped from windows, doors, or counters and bulletproof, or bullet-resistant, transparent glass substituted in its place. In vehicles, armored panels or plating may be disposed in doors and behind vehicle panels around the vehicle to bulletproof passenger compartments. All of this significantly increases the weight of the retrofit vehicle.

Bulletproof glass must necessarily be capable of preventing penetration through the glass of a predetermined caliber of rifle bullets, such as 7.62×39 mm (AK-47), 7.62×51 mm (0.308), and 5.56 (0.223). Standard impact ratings have developed over time in the industry, including the UL rating system (Underwriter's Laboratory) for indicating the caliber size of bullets to which ballistic glass is penetration resistant. These ratings, in various embodiment, include Level 1 (glass capable of withstanding projectiles fired from small caliber handguns), Level 2 and so on, and also including various subgrades such as Level 5A and 5B. Ballistic glass may become damaged in combat conditions when multiple impacts from automatic fire strike the glass which penetrates glass surfaces. Thus, the glass becomes weaker with each successive impact.

Level 1: Refers to ballistic glass able to withstand fire from small caliber handguns, including a minimum of three 9 mm FMJs traveling at a minimum velocity of 1,175 feet per second (f/s).

Level 2: Defines ballistic glass designed to withstand fire from larger caliber handguns, including the capability of withstanding at least three shots of 0.357 magnum soft points traveling at a velocity of 1,250 f/s.

Level 3: Includes ballistic glass which can withstand a minimum of three shots of 0.44 magnum rounds at a velocity of 1350 f/s.

Level 4: Includes ballistic glass capable of withstanding at least one shot from a .30 caliber rifle with a minimum velocity of 2540 f/s.

Level 5: Includes ballistic glass designated to withstand at least one 7.62 mm rifle FMJ with a velocity of at least 2750 f/s.

Level 6: Includes ballistic glass designed to withstand at least five 9 mm rounds traveling at an elevated minimum velocity of 1400 f/s.

Level 7: Includes ballistic glass designed to withstand multiple hits with 5.56 rifle FMJs with a minimum velocity of 3080 f/s.

Level 8: Designates the highest level of protection available in ballistic glass capable of withstanding at least five shots from a 7.62 mm rifle.

Traditional ballistic glass is generally unable to withstand repeated impact from standardized military rounds which proliferate across the world, including 5.56×45 mm (0.223), 7.62×39 mm (AK-47), and 7.62×51 mm (0.308). Armor able to withstand repeatedly impact of these rounds is too thick to be efficiently used and disposed within doors of vehicles or window frames, or even in buildings.

As ballistic glass is meant to protect individuals, it is commonly used in military and government application, such as armored personnel carriers and armored cars, as well as buildings and other structures. Ballistics may include not just bullets but shrapnel and shock waves generated by nearby explosions from mines, roadside bombs, and improvised explosive devices.

While ballistic glass is commonly laminated and may include sheets of glass, it is difficult to stack, or layer, multiple layers of hard materials together as each differing type of hard material as different thermal expansion properties. For this reason, as glass is heated, cured, or even exposed to the elements after being installed, one hard layer will weaken an adjacent hard layer.

When a ballistic projectile hits a ballistic glass, the projectile perforates the glass and carries before it a shock wave of compressed ambient air. Current glass in the industry provides no means of dissipating this shock wave, which contributes to perforation.

It is therefore desirable that a multi-layered ballistic glass be provided which overcomes these difficulties, which is lightweight, which dissipates shockwaves, and which overcomes thermal expansion difficulties, and which is slidably affixable within doors and vehicle frames.

### SUMMARY OF THE INVENTION

From the foregoing discussion, it should be apparent that a need exists for a more efficient multi-layered ballistic glass with impact-dampening and spalling-resistant properties. Beneficially, such a glass would overcome many of the difficulties of the prior art by providing multi-layered ballistic glass which is light weight and modularized.

The present invention has been developed in response to the present state of the art, and in particular, in response to the problems and needs in the art that have not yet been fully solved by currently available apparati and methods. Accordingly, the present invention has been developed to provide a multilayered composite ballistic glass comprising: a plurality of hard layers, each hard layer comprising one or more of: a silica-based chemically-tempered glass sheet, an acrylic, an annealed silica glass, and a polycarbonate; one or more flexible films bonded to a hard layer, each flexible film comprising a vinyl polymer adapted to prevent spalling; a recto surface formed of a flexible film; wherein the rearmost hard layer comprises polycarbonate; wherein adjacent hard layers are not bonded to one another.

The foremost hard layer may comprise a silica-based glass. Two or more hard layers may be adapted and/or positioned to form a recess into which is injected one of: a liquid laminate, a silicone sealant, and a clear butyl.

The layers may be cut to a predimensioned form and size. One or more of the layers of the ballistic glass may be heat-tempered.

The vinyl is one of polyethylene terephthalate (PETG) and polyvinyl chloride (PVC).

The ballistic glass may further comprise one or more aluminsilicate glass sheets having high compressive strength. The multilayered glass may be convex.

The ballistic glass may further comprise a plurality of forms bonded to upper, lower and side edges of the ballistic glass.

A second multilayered composite ballistic glass is provided comprising: a plurality of sections, each section comprising: a plurality of convex hard layers, each hard layer comprising one of: a silica-based chemically-tempered glass sheet, an acrylic, an annealed silica glass, and a polycarbonate; wherein the rearmost hard layer comprises polycarbonate; wherein the foremost hard layer comprises one of acrylic and a silica-based glass; one or more flexible films between 0.004 and 0.048 inches thick bonded to a hard layer, each flexible film comprising a vinyl polymer, the film adapted to dampen vibrations of a bullet impacting said ballistic glass; a recto surface formed of a flexible film; wherein adjacent hard layers are not bonded to one another.

The foremost hard layer may comprise a silica-based glass.

Each section may be convex and arched to differing angles. Two or more hard layers may be form a recess into which is injected one of: a liquid laminate, a silicone sealant, and a clear butyl.

One or more layers may comprise a polycarbonate coated on one face with an acrylic coating. In various embodiments, an acrylic and/or silicone abrasive, resistive coating is applied to one or more layers.

A third multilayered composite ballistic glass is provided comprising: a plurality of hard layers, each hard layer comprising one or more of: a silica-based chemically-tempered glass sheet, an acrylic, an annealed silica glass, and a polycarbonate; one or more flexible films bonded to a hard layer, each flexible film comprising a vinyl polymer adapted to prevent spalling; a recto surface formed of a flexible film; wherein one layer comprises polycarbonate; wherein adjacent hard layers are not bonded to one another.

The double-sided spacer tape may be adhered to a perimeter of a layer to form a recess forms between one or more layers.

A recess may dispose between a first and second layer, wherein the first layer comprises of a film and the second layer comprises one of a film and polymeric sheet.

The ballistic glass may further comprise a plurality of gridlines disposed between adjacent layers. The ballistic glass may further comprise a layer comprising smart glass. The smart glass may be operable to transform the smart glass an opaque color.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side perspective view of multi-layered ballistic glass in accordance with the present invention;

FIG. 2A is a side perspective view of multi-layered ballistic glass in accordance with the present invention;

FIG. 2B is a side perspective view of multi-layered ballistic glass in accordance with the present invention;

FIG. 3 is a side perspective view of traditional glass in accordance with the prior art;

FIG. 4A is a sectioned side perspective view of concave ballistic glass in accordance with the present invention;

FIG. 4B is a sectioned side perspective view of concave ballistic glass in accordance with the present invention;

FIG. 5 is an environmental perspective view of a vehicle retrofit with ballistic glass in accordance with the present invention;

FIG. 6 is a flow chart illustrating the steps of a method for manufacturing ballistic glass in accordance with the present invention; and

FIG. 7 is a perspective view of sections of ballistic glass in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Components indicated with a numeral followed by a lowercase letter, such as 106a, indicate said component may be one of a plurality of components referenced by the numeral alone (e.g., wherein 106a is one of a plurality of 106).

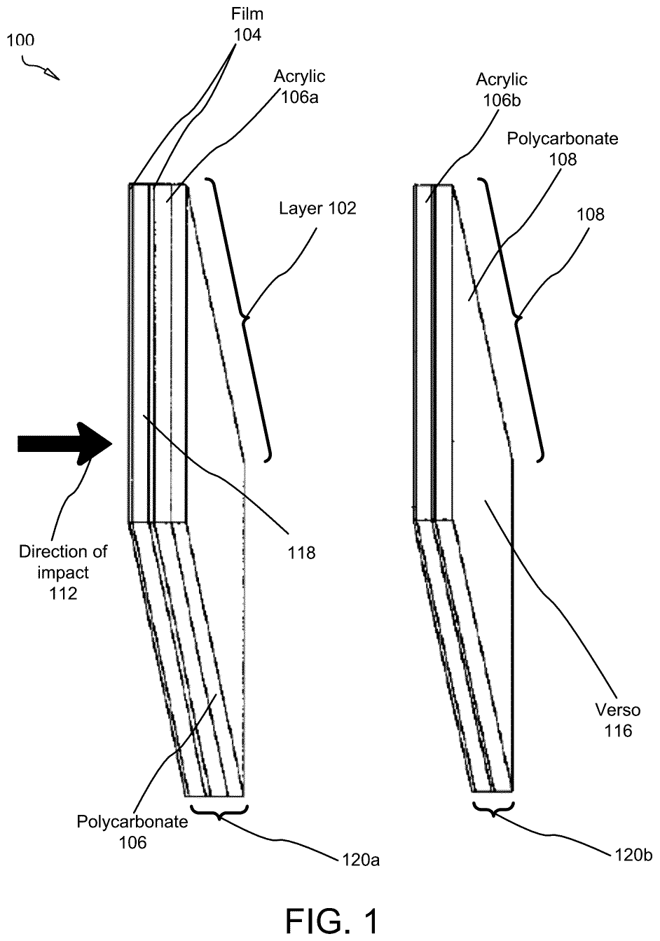

FIG. 1 illustrates a side perspective view of multi-layered ballistic glass 100 in accordance with the present invention.

The glass 100, as shown, comprises a plurality of layers 102 (the layers including, in some embodiments, film 104, acrylic 106, a clear butyl 204, a glass 210, and a liquid laminate 202). In various other embodiments, the glass 100 comprises a polyurethane or ionomer monomer. Additionally, the glass 100 may comprise layers of lead glass, glass-ceramic, or sodium-calcium glass. The glass-ceramic have a crystallinity of 40% or more volume to weight ratio.

Face-to-face adherence may alternatively or additionally include pressure sensitive adhesives or wet application of film 104 to a hard layer.

The multilayered glass 100 may be formed from a plurality of silica-based chemically-tempered or heat-tempered glass sheets or annealed silica glass, which may be cut to a predimensioned form or formed within a mold or tool. The glass 100 may include multiple layers of glass 210, which glass 210 may comprise one or more of soda-lime glass, silica sand, soda ash, limestone, cobalt, dolomite, and iron oxide.

In various embodiments, the glass 210 comprises, or is adhered to or abuts, one or more aluminsilicate glass sheets having high compressive strength. Additionally, each sheet of silica glass 210 and/or acrylic 106 may be adhered, on recto and verso faces, to a film 104.

In various embodiments, the glass 100 is adapted to resist unidirectional impact, but may also be adapted for omnidirectional impact resistance. The glass 100, 150 comprises a forward side (i.e., recto 114) and a reverse side (i.e., verso 116). The glass 100 is positioned within vehicles 504, window frames, or structures such that the recto 114 is outwardly facing and the first surface to absorb impact from a bullet 302.

The outer layer on the forward face 114 (or recto) of the glass 100, in the preferred embodiment, comprises an outer film of 0.004 inches (4 mils) to 0.024 inches (24 mils), adhered to a sublayer 118. The sublayer 118 may comprise glass 210 or acrylic 106; however, the polycarbonate 108 layer always positions behind other hard layers of the glass 100 such that the polycarbonate 108 layer disposes toward the verso 116. In some embodiments, the polycarbonate 108 forms the verso 116.

The film 104 may comprise a hydrophobic polymer layer.

It is a common misconception that the glass 100 should optimally be adapted only to withstand the impact force of a bullet 302 along its direction of travel 112. In fact, one of the primary reasons that traditional glass known in the art, including glass 300, fails to withstand the impact of a bullet 302 is because the bullet 302 oscillates or vibrates as it strikes the glass 100, 300. For this reason, by incorporating as the present invention does, a plurality of hard layers (such as acrylic 106, glass 210 and polycarbonate 208) and soft layers (such as film 104, clear butyl 204, and/or liquid laminate 202), the vibrations of the projectile or bullet 302 as it strikes the glass 100 are dampened, adding additional strength to the glass 100. In particular, soft layers may be disposed toward the recto 114 and hard layers toward the verso 116. The soft layers are further adapted to maintain the integrity of the glass during successive bullet 302 impacts to the glass 100.

In various embodiments, soft layers position between hard layers having different coefficients of thermal expansion and/or elasticity. For instance, a film may position between polycarbonate 108 and glass because polycarbonate characteristically expands more than glass during heating. In this way, the thermal expansion of one layer does not damage another layer.

Additionally, for this reason and others, not all of the layers 102 are bonded together. In various embodiments, the soft layers are bonded to all adjacent hard layers while the adjacent hard layers are not bonded to each other, allowing one hard layer to crack, vibrate and shift microscopically and independently of a subsequent, adjacent hard layer. By not binding hard layers to adjacent hard layers, layers can be stacked with differing coefficients of thermal expansion.

In this manner, the glass 210 becomes modularized. For instance, differing sections 120 (or assemblies) of the glass 100 may be manufactured or layered independently of one another, then inserted into a frame or vehicle one at a time without the need to bond the sections 120 together.

Because traditional glass 300, as well as glass 100, can weigh as much as 30 pounds per square foot or more, the modularized section 120 impart an efficiency in construction of the glass 100, importantly facilitating stacking of the sections 120 of glass 100 during assembly. This is possible because the layers 102 and/or section 120 are not all bonded together, allowing the glass sections 120 to be lifted and fit in place by hand.

In various embodiments, the multilayered ballistic glass 100, including all of its layers 102, may less than 1.5 inches thick while still meeting or exceeding the same impact specifications of competing glass which is 50% thicker.

In various embodiments, Level 2 glass may be layered from recto 114 to verso 116 as follows lists comprise: 104-106-104-108 or 104-106-104-210-108. Level III glass may be layered as follows: 104-106-104-108-210-108. Level 6 glass may be layered: 104-210-104-106-210-108.

Where appropriate, some layers 102 may be rigidly formed with a resin-catalyst mixture.

The film 104 may comprise a vinyl interlayer such as polyvinyl chloride. The film 104 may be between 4 mil to 20 mil. In other embodiments, the film 104 may be up to 24 mil thick. The film 104 may also comprise a PETG (polyethylene terephthalate) with an acrylic pressure-sensitive adhesive on one side. In still further embodiments, the film 104 comprises a polyester, FEP (Fluorinated Ethylene Propylene), PFA (perfluoroalkoxy alkane), ETFE (ethylene tetrafluorethylene), or PET. Recognizing that even polycarbonate can be become flexible if cut or formed from thin enough sheets, in various embodiments, a soft layer film 104 may comprise thin polycarbonate as well.

The incorporation of soft layers into the glass 100, 200 creates spalling-resistant properties because of the multiple interlayers of inter alia film 104, a butyl 204, and liquid laminate 202. Additionally, by layering the glass 100 as taught, the glass 100 can be adapted for hurricane-resistant applications as well as becomes hurricane compliant under standards adopted by, inter alia, the State of Florida.

The glass 210 may be 0.25 inches thick. The polycarbonate 108 may be 0.25 inches thick.

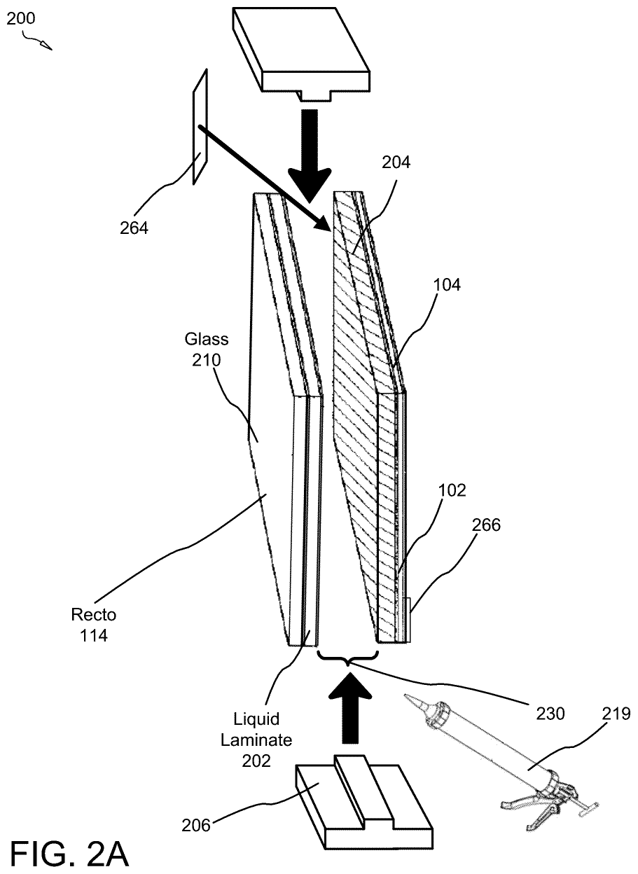

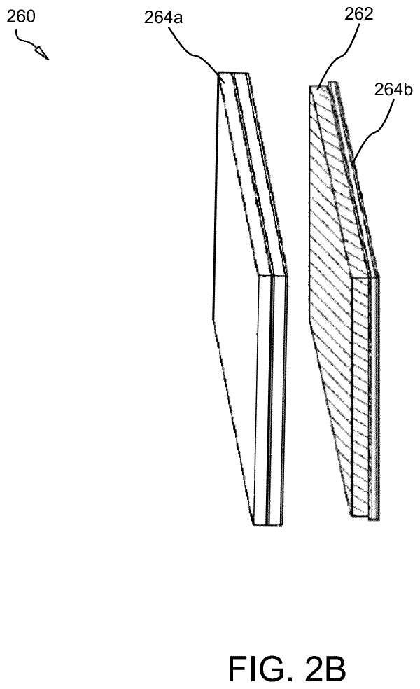

FIGS. 2A-2B present side perspective view of multi-layered ballistic glass 200, 260 in accordance with the present invention.

In various embodiments, sections 120 of the glass 200, or layers of the glass 200, may be formed within forms 206 (or implements, molds or tools). The sections 120 may be spaced apart to form a recess 230 between the section 120. This recess 230 may be filled or injected with a clear English butyl 204 or a liquid laminate 202. The forms 206 may be t-shaped and may position on the top, bottom, and side surfaces of the ballistic glass.

In various other embodiments, the recess 230 is filled with an insulating noble gas such as argon. In these embodiments, the recess 230 serves to dissipate the shock wave of the bullet as it penetrates forward surfaces of the glass 100. In various other embodiments, the recess is a vacuum which allows a shock wave in front of the bullet to dissipate into the vacuum.

In various embodiments, a recess 230 is disposed between, and forms between, some or all of abutting layers wherein both layers comprise or consist of a film 104, or wherein one layer consists of a film 104 and another of a polycarbonate 108. In various embodiments, a recess is disposed between any abutting layers wherein both one layer comprises or consists of a film 104 and the other layer comprises or consists of a polymeric sheet. In various embodiments, the recess 230 forms when a portion of the film 104 is removed, or omitted, from adherence to a glass sheet 210. For instance, an inner region of the film 104 may be cut away, leaving a recess 230 where the cut away portion of the film 104 formerly positioned.

In some embodiments, double-sided spacer tape 264 (or a silicone layer in other embodiments) is adhered around a perimeter of a first layer 102 and then adhered to a second layer 102. The space between the layers 102 is filled only around the perimeter with double-sided spacer tape 264, defining a recess 230 between the layers 102. The recess 230 may additionally serve the purpose of reducing sound outside the glass 200 by creating a sound barrier and/or insulating the glass 200. In various embodiments, the glass 700 is referred to herein as an insulated glass unit (IGU).

In various embodiments, a robotic arm applies the space tape 264 (or various silicone beads) to a layer 102. The spacer tape may bet 12-20 mills thick.

In some embodiments, an acrylic coating 266 is coated across a recto or verso face of a polycarbonate layer 108. In various embodiments, an acrylic and/or silicone abrasive, resistive coating is applied to one or more layers 102.

In some embodiments, the sections 120 differ in size and shape. In these embodiments, the larger section 120 may be used to dispose within a doorframe or vehicular window frame with the smaller section overhanging the doorframe, vehicular window frame, or the like.

The liquid laminate 202 may comprise a PVB (polyvinyl butyral) interlayer.

In other embodiments further described below, the liquid laminate 202 may be injected between curved layers 102 or sections 120 because the liquid laminate 202 may cure or harden after injection. Alternatively, recesses between layers may be filled with a silicone sealant 219 such as DOW 995 (or DOWSIL™ 995 Silicone Structural Sealant). In these embodiments, the recess 230 serves to dissipate the shock wave of the bullet as it penetrates forward surfaces of the glass 100. In various other embodiments, the recess is a vacuum which allows a shock wave in front of the bullet to dissipate into the vacuum.

In still further embodiments, DOW is bonded to the outside edges of the glass 100.

Edge of the combined glass 200 (having combined sections 120) may sealed with Dow Corning 995 silicone structure. The forms 206 may integrate with the combined glass 200 along top or bottom edges of the glass 200.

The completed glass 200 may be baked in an autoclave. In various embodiments, the sections of the glass are separately baked in an autoclave at differing pressures and temperatures to homogenize said layers or sections. In other embodiments, the recesses 230 are filled using a plastic reflow process.

Tint may be incorporated into the layers 102 or the layer 102 may comprise tint or other color-absorbent materials such as cobalt. In various embodiments, polarized or painted glass in incorporated.

In various embodiments, the layers 102 on the recto and verso comprise out layers 264. Inner layers 262 likewise position between the outer layers 264. In various embodiments, the inner layers 262 are formed and dimensioned to a smaller size than the outer layers 264a-b. This configuration facilitates the use of sealants, jigs, forms, implements and structural elements around a perimeter of the glass 260.

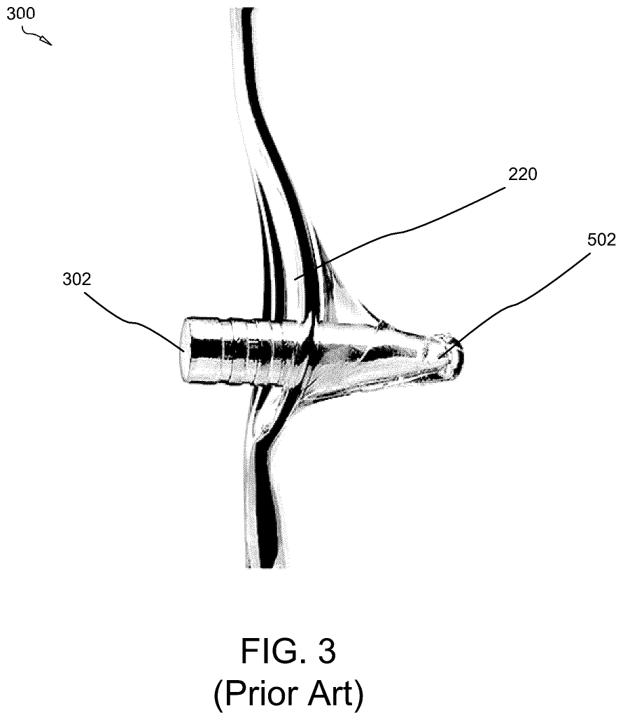

FIG. 3 is a sectioned side perspective view of traditional glass 300 in accordance with the prior art.

With regard to traditional glass 300, the glass 300 deforms upon impact of a bullet 302 formed an impact crater 502 at the impact point 220. This deformation is caused by the forward momentum of the bullet 302 in the direction of impact 112 as well as by lateral and longitudinal vibrations within the bullet 302.

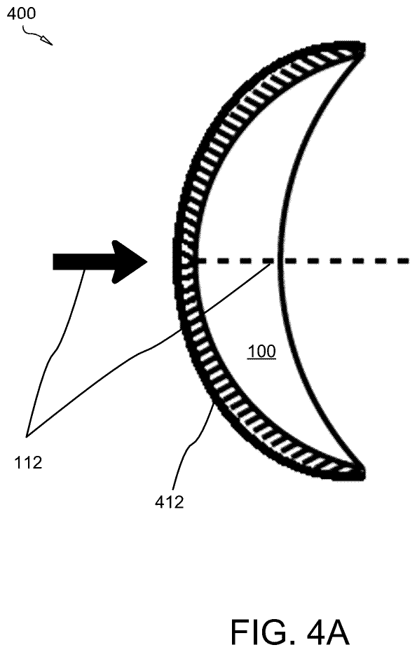

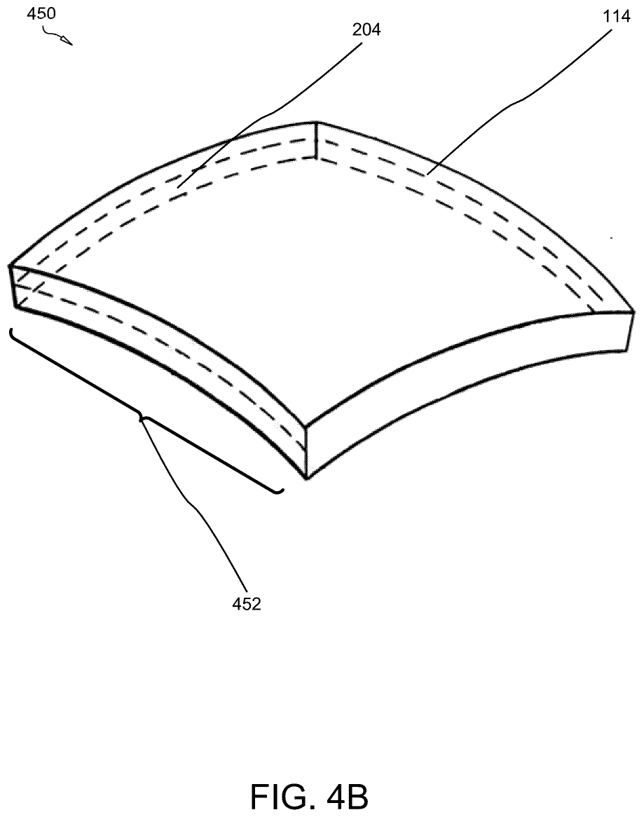

FIGS. 4A-4B illustrate sectioned side perspective views of concave ballistic glass 400, 450 in accordance with the present invention.

Additional bullet resistant strength may be provided by layering convex bullet-resistant materials, but such layering is unknown in the art. In various embodiments, the recto 114 is convex, which allows the glass 400, 450 to absorb high impact forces. Consequently, the recto 116 is therefore concave in various embodiments; however, in some embodiments of the present invention, the concave recess 452 formed behind the concave verso 116 is backfilled with a butyl 204 or liquid laminate 202.

The degree of arch of the recto 114 in a convex direction may optimized for the strength of the polycarbonate 108 layer without regard to the degree (or angle or magnitude), of arch of the remaining layers 102. In terms of Euclidean geometry, the segment forming the arc 412 through any layer 102 of the glass 400, 450 may be optimized to maximize the strength of said layer. In this manner, the segments 412 forming each layer 102 of the glass 400, 450 may differ slightly from one another in length and degree to which the arc is formed.

By injecting soft layers between sections 120 of the glass 400, 450, the sections can be curved or arched independently of one another then bonded or joined together using the soft layers injected into the recess 230 between sections 120.

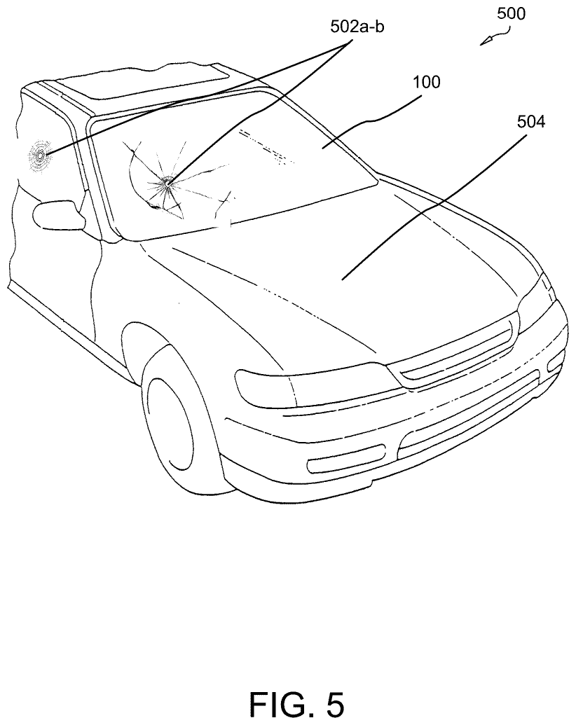

FIG. 5 is an environmental perspective view of a vehicle 504 retrofit with ballistic glass 199 in accordance with the present invention.

Impact craters 502 are shown on the impacted glass 100.

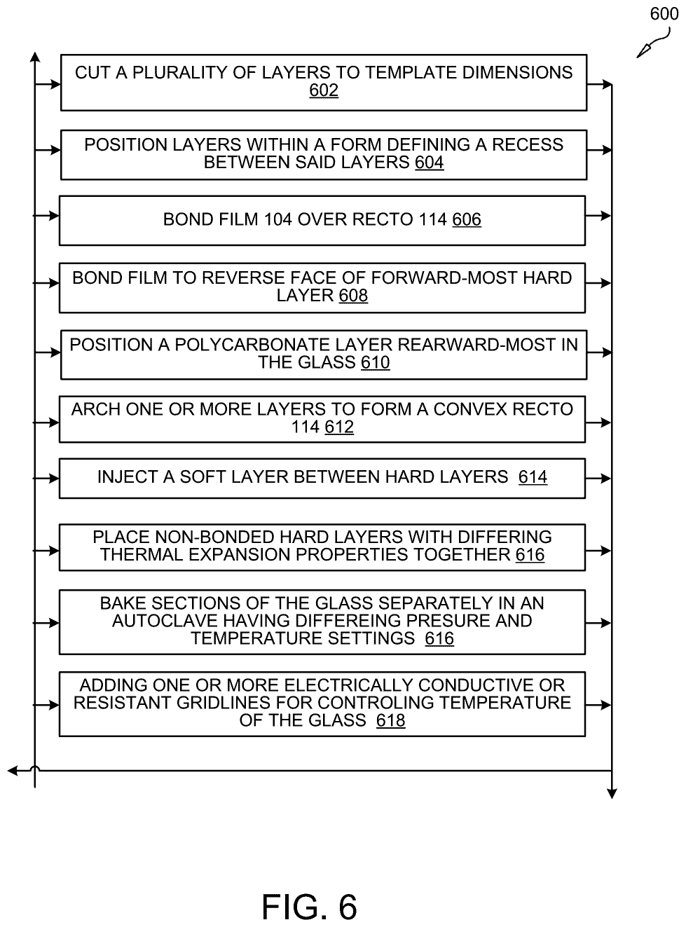

FIG. 6 is a flow chart illustrated the steps of a method for manufacturing ballistic glass in accordance with the present invention.

The windows are shown at 202. The windshield is shown at 204.

Each of the layers may cut to predetermined size and form and layered one upon the other. Each layer 102 may be heat-pressed or adhered to an adjacent layer 102. The exteriorly-facing surface of the multi-layered ballistic glass may convex, increasing the impact-resistance of the glass.

In various embodiments, a plurality of layers 102 are cut 602 to a predetermined size and shape. Additionally or alternatively, the layers 102 may be positioned 604 within a form 206.

Some of the layers 102 may be adhered or bonded to one another. For instance, film 104 may be bonded to a hard layer. In various embodiments, a film 104 is bonded 608 to a reverse surface and forward surface of the hard layer 102 disposed forwardly in the glass 100, be this hard layer 102 one of acrylic 106, polycarbonate 108, or glass 210.

In the preferred embodiment, a polycarbonate layer 108 positions 610 behind, or rearwardly to, the remaining layers 102 of the glass 210. In this manner the softer layers are braced by the harder, but more brittle, polycarbonate layer 108.

One or more of the layers 102 may be curved or arched 612 to form a convex recto surface 114.

A clear butyl (or English butyl), or soft layer, may be injected 614 between various sections 120 of the glass, comprising or consisting of a clear butyl tape.

In some embodiments, a film 104 positions on the verso 116 surface of the ballistic glass 400.

As described above, in some embodiments sections of the glass 100 are separately baked 618 in autoclaves are differing predetermined temperatures and pressures, as well as for differing durations.

Hard layers having differing thermal expansion properties may be placed 616 adjacent to one another without being bonded together.

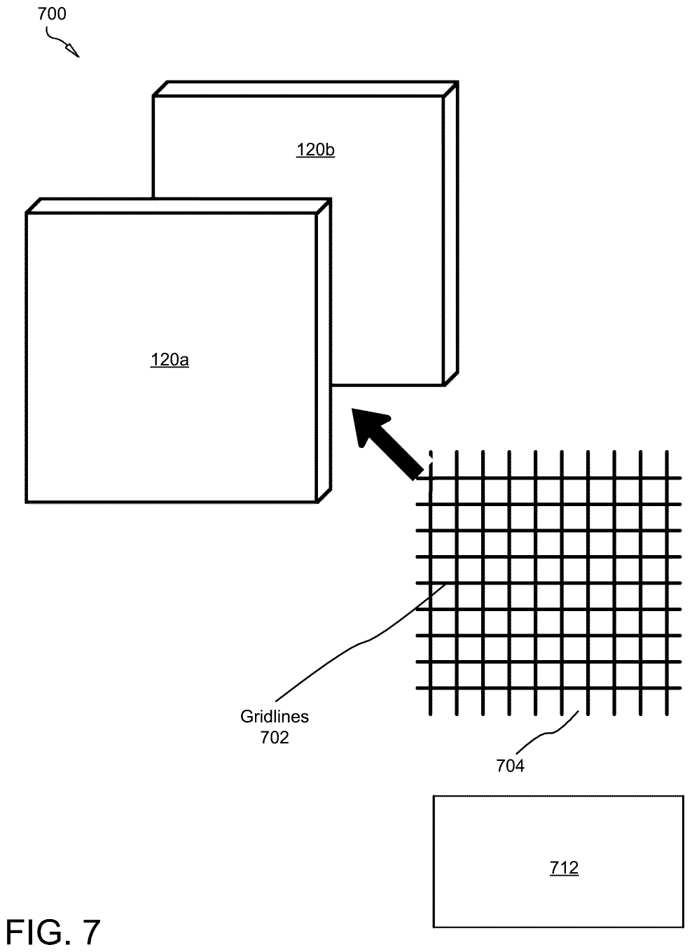

FIG. 7 is a perspective view of sections of ballistic glass in accordance with the present invention.

In various embodiments, gridlines 702 dispose between layers 102 and/or sections 120. The gridlines 702 typically comprise a plurality of horizontal and vertical lines 704 (or vertices) forming a lattice or lattice graph, mesh, or grid is some embodiments. The lines 704 are bipartite. In various embodiments, the gridlines 702 is formed from a metal alloy or polymeric structure, with all the lines 704 formed either as integrated piece or adjoined together using means known to those of skill in the art.

In some embodiments, the gridlines 702 are formed from latticed steel adapted to reinforce the glass 100. In other embodiments, the gridlines 702 comprise heat traces (or heat trace cables), in electrical connectivity with an outside power supply, adapted to heat the glass 700 and defrost the same.

In some embodiments, the glass 700 alternatively or additionally comprises muntin bars.

The gridlines 702 may be formed from graphene. In other embodiments, one or more of the layers 102 comprise graphene for reinforcement purposes. In still additional or alternative embodiments, a layer 102 is etched with gridlines 704 and the etched gridlines 704 are filled with a thin, almost invisible, layer of graphene, or an electrical conductor. In various embodiments, these etched gridlines 704 are used for shot detection function. The electrical conductivity of each graphene (or metal or metal alloy) line forming the columns and rows of the gridlines 704 may separately measured for disturbances in electrical conductivity, allowing a data processing device (DPD) to identify the row and column which is suddenly disturbed, indicating a sector or region of projectile impact. By selectively interspersing, or stacking, a plurality a gridlines 704 throughout the thickness of the glass 700 between, or within, layers 102, the glass 700 may also measure the depth to which a projectile 302 has penetrated the glass, allowing the DPD to determine which type of projectile has penetrated the glass 700.

Additionally, as mentioned above, the columns and rows may be used as heating elements for defrosting the glass 700, in which case the rows and columns of the gridlines 704 may be adapted to include an electrically-resistant material for dispersing heat. In this manner, the gridlines 704 may also be used to heat the glass 700 or layers 102 within the glass 700. In this manner, the temperature of differing layers 102 of the glass may be controlled. Recognizing that hard layers such as polycarbonate may become more or less brittle with nonoptimal temperatures, the strength of the overall glass 700 may be regulated with the gridlines' 704 temperature control function in some embodiments.

In various embodiments, the glass 700 comprises layer, film, sheet or coating of smart glass 712. This smart glass 712 (also called light control glass or switchable glass or tintable glass or dynamic glass) is adapted to vary an amount of light transmitted through the glass 700, allowing the glass 700 to appear transparent, translucent, or opaque. This smart glass 712 may be active or passive, and may comprise one or more of: a polymer dispersed liquid crystal (PDLC), a suspended particle device (SPD), electrochromic (EC) or using other means known to those of skill in the art. In the case of PDLC, particles dispersed throughout the smart glass 712 are adapted to disperse or align when an electric current is applied to the smart glass 712.

In still further embodiments, the gridlines are etched or drawn on a verso 116 face of one or more of the sections 120.

The recto 116 and verso 120 faces may alternatively be termed exterior and interior faces, or obverse and reverse. In addition to the functional structure of the glass 700, the glass 700 may be modified for aesthetic purposes, including etching stylistic or ornamental patterns into the glass 700 and/or staining and dying one or more layers 102 of the glass 700.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A multilayered composite ballistic glass comprising:
a plurality of hard layers, each hard layer comprising one or more of:
a silica-based chemically-tempered glass sheet,
an acrylic,
an annealed silica glass,
a heat-tempered glass, and
a polycarbonate;
one or more flexible films bonded to a hard layer, each flexible film comprising a vinyl polymer adapted to prevent spalling;
a recto surface formed of a flexible film;
wherein the rearmost hard layer comprises polycarbonate;
wherein adjacent hard layers are not bonded to one another.

2. The ballistic glass of claim 1, wherein two or more hard layers are adapted to form a recess into which is injected one of: a liquid laminate, a silicone sealant, and a clear butyl.

3. The ballistic glass of claim 1, wherein inner layers are smaller in size than outer layers.

4. The ballistic glass of claim 1, further comprising one or more gridlines comprising an electrically conductive material, wherein said gridlines are operable to heat the ballistic glass and regulate a brittleness of one or more layers thereof.

5. The ballistic glass of claim 1, wherein one or more layers are etched with columns and rows, said etched columns and rows filled with one of graphene, an electrical conductor, and an electrical resistor, wherein an electrical current through each row and column is monitored by a data processing device (DPD) to identify a row and column which is affected by a projectile impact.

6. The ballistic glass of claim 1, wherein the vinyl is one of polyethylene terephthalate (PETG) and polyvinyl chloride (PVC).

7. The ballistic glass of claim 1, further comprising one or more aluminsilicate glass sheets having high compressive strength.

8. The ballistic glass of claim 1, wherein the multilayered glass is convex.

9. The ballistic glass of claim 1, further comprising a plurality of forms bonded to upper, lower and side edges of the ballistic glass.

10. A multilayered composite ballistic glass comprising:
a plurality of sections, each section comprising:
a plurality of convex hard layers, each hard layer comprising one of: a silica-based chemically-tempered glass sheet, an acrylic, an annealed silica glass, and a polycarbonate;
wherein the rearmost hard layer comprises polycarbonate;
wherein the foremost hard layer comprises one of acrylic and a silica-based glass;
one or more flexible films between 0.004 and 0.048 inches thick bonded to a hard layer, each flexible film comprising a vinyl polymer, the film adapted to dampen vibrations of a bullet impacting said ballistic glass;
a recto surface formed of a flexible film;
wherein adjacent hard layers are not bonded to one another.

11. The ballistic glass of claim 10, wherein the foremost hard layer comprises a silica-based glass.

12. The apparatus of claim 10, wherein each section is convex and arched to differing angles.

13. The ballistic glass of claim 10, wherein two or more hard layers are adapted to form a recess into which is injected one of: a liquid laminate, a silicone sealant, and a clear butyl.

14. The ballistic glass of claim 10, where one or more layers comprising polycarbonate are coated on one face with an acrylic coating.

15. A multilayered composite ballistic glass comprising:
a plurality of hard layers, each hard layer comprising one or more of:
a silica-based chemically-tempered glass sheet,
an acrylic,
an annealed silica glass, and
a polycarbonate;
one or more flexible films bonded to a hard layer, each flexible film comprising a vinyl polymer adapted to prevent spalling;
a recto surface formed of a flexible film;
wherein one layer comprises polycarbonate;
wherein adjacent hard layers are not bonded to one another.

16. The ballistic glass of claim 15, wherein double-sided spacer tape is adhered to a perimeter of a layer to form a recess between one or more layers which is impermeable and impervious to moisture-penetration.

17. The ballistic glass of claim 15, a recess is disposed between a first and second layer, wherein the first layer comprises of a film and the second layer comprises one of a film and polymeric sheet.

18. The ballistic glass of claim 15, further comprising a plurality of gridlines disposed between adjacent layers.

19. The ballistic glass of claim 15, further comprising a layer comprising smart glass.

20. The ballistic glass of claim 19, wherein the smart glass is operable to make the smart glass opaque.
